(19) United States
(12) Patent Application Publication
(10) Pub. No.: US 2026/0018663 A1
(43) Pub. Date: Jan. 15, 2026

(54) SOLID ELECTROLYTE, MANUFACTURING METHOD OF THE SAME, AND NON-PRESSURIZED SECONDARY BATTERY INCLUDING THE SAME

(71) Applicant: POSTECH RESEARCH AND BUSINESS DEVELOPMENT FOUNDATION, Pohang-si (KR)

(72) Inventors: Soojin PARK, Pohang-si (KR); Hyeongseok LEE, Pohang-si (KR); Jihun SUNG, Pohang-si (KR)

(73) Assignee: POSTECH RESEARCH AND BUSINESS DEVELOPMENT FOUNDATION, Pohang-si (KR)

(21) Appl. No.: 19/262,720

(22) Filed: Jul. 8, 2025

(30) Foreign Application Priority Data
Jul. 9, 2024 (KR) 10-2024-0090602

(51) Int. Cl. H01M 10/0562; H01M 4/02; H01M 4/40; H01M 4/58; H01M 4/80

(52) U.S. Cl. CPC H01M 10/0562; H01M 4/405; H01M 4/5815; H01M 4/80; H01M 2004/021; H01M 2004/027; H01M 2004/028; H01M 2300/0068

(57) ABSTRACT

A solid electrolyte includes an organic polymer represented by Chemical Formula 1. The polymer comprises a repeating unit having at least one of ester, thioester, or dithioester linkages, and may include alkyl, aryl, or heteroaryl substituents. The solid electrolyte exhibits enhanced ionic conductivity and thermal stability, making it suitable for application in a non-pressurized secondary battery. A method for preparing the solid electrolyte involves polymerizing a monomer containing functional groups defined in Chemical Formula 1 under controlled conditions. The secondary battery includes the solid electrolyte and demonstrates improved cycle characteristics and safety. The invention provides a solid electrolyte solution that enables safer battery designs for non-pressurized secondary batteries without compromising performance.

### TECHNICAL FIELD

The present invention relates to a secondary battery, and more particularly, to a solid electrolyte comprising an organic polymer, a method for manufacturing the same, and a non-pressurized secondary battery comprising the same.

### BACKGROUND OF THE INVENTION

In recent years, the intensification of global warming has led to growing efforts to replace internal combustion engine-based means of transportation, which are among its main causes. In this context, electric vehicles, which are zero-emission modes of transport, have emerged as a viable solution, and the lithium-ion battery industry, which functions as the engine of electric vehicles, is rapidly expanding. Currently, most lithium-ion batteries use a mixture of organic solvents and salts as electrolytes; however, such electrolytes are highly flammable and thus lack safety, making them unsuitable for use in electric vehicles. Attempts have been made to prevent ignition of lithium-ion batteries in electric vehicles through structural improvements, but these have not been highly effective.

As an alternative, all-solid-state batteries composed of flame-retardant materials have been proposed, which exhibit an extremely low risk of explosion or ignition compared to conventional lithium secondary batteries using liquid electrolytes. In addition, they can be designed to achieve a significantly higher energy density than currently available liquid-electrolyte-based batteries by maximizing capacity per unit volume and weight.

All-solid-state batteries generally use electrolytes composed of inorganic material particles. However, when lithium metal is used as the negative electrode, lithium tends to be reduced and penetrate through the grain boundaries of the inorganic particles, frequently causing internal short circuits. Moreover, due to the solid-state nature, once contact between electrolyte particles is lost, it cannot be recovered, which leads to degradation in battery performance.

Although this can be alleviated by operating the battery under very high pressure (several to several tens of MPa), implementing such pressure-driven operation for large-area batteries in commercial applications requires additional equipment, which reduces energy density or renders pressurization virtually unfeasible. Therefore, improvements in this regard are necessary.

### SUMMARY OF THE INVENTION

### Problem to be Solved

According to one embodiment of the present invention, the solid electrolyte can improve electrical and chemical stability when applied to a secondary battery.

According to another embodiment of the present invention, the method for manufacturing the solid electrolyte enables the preparation of a solid electrolyte having the above-described advantages.

According to yet another embodiment of the present invention, the non-pressurized secondary battery includes the solid electrolyte having the aforementioned advantages, thereby improving electrical and chemical stability.

### Means for Solving the Problem

According to one embodiment of the present invention, the solid electrolyte comprises an organic polymer comprising the following Chemical Formula 1:

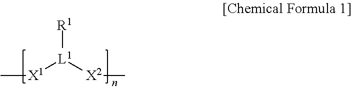

(In Chemical Formula 1, X₁ and X₂ are each independently O, S, S—S, a substituted or unsubstituted ester, thioester, or dithioester, and at least one of X₁ and X₂ is present; R₁ is hydrogen, deuterium, tritium, a halogen group, a substituted or unsubstituted C₁-C₃₀ alkyl group, a substituted or unsubstituted C₆-C₃₀ aryl group, a substituted or unsubstituted C₂-C₃₀ heteroaryl group, or a substituted or unsubstituted silyl group, acyl group, alkoxy group, ester group, ketone group, aldehyde group, carboxyl group, thioester group, or dithioester group; L₁ is a direct bond, a substituted or unsubstituted C₁-C₁₀ alkylene group or an isomer thereof, a substituted or unsubstituted C₆-C₃₀ aryl group, a substituted or unsubstituted C₂-C₃₀ heteroaryl group, or a substituted or unsubstituted silyl group; and n is an integer from 1 to 50,000.)

A terminal of the organic polymer may comprise at least one of Chemical Formula 2 and Chemical Formula 3:

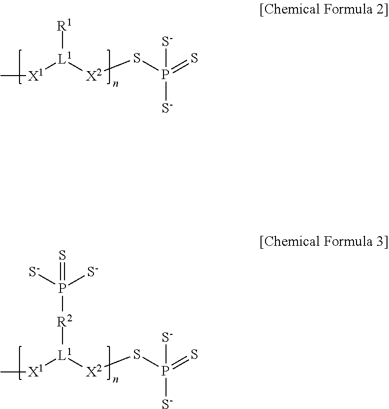

(In Chemical Formulas 2 and 3, X₁ and X₂ are each independently O, S, S—S, a substituted or unsubstituted ester, thioester, or dithioester, and at least one of X₁ and X₂ is present; R₁ is hydrogen, deuterium, tritium, a halogen group, a substituted or unsubstituted C₁-C₃₀ alkyl group, a substituted or unsubstituted C₆-C₃₀ aryl group, a substituted or unsubstituted C₂-C₃₀ heteroaryl group, or a substituted or unsubstituted silyl group, acyl group, alkoxy group, ester group, ketone group, aldehyde group, carboxyl group, thioester group, or dithioester group; R₂ is a substituted or unsubstituted C₁-C₃₀ alkyl group or an isomer thereof, a substituted or unsubstituted C₆-C₃₀ aryl group, a substituted or unsubstituted C₂-C₃₀ heteroaryl group, a substituted or unsubstituted silyl group, acyl group, alkoxy group, ester group, ketone group, aldehyde group, or carboxyl group; L₁ is a direct bond, a substituted or unsubstituted C₁-C₁₀ alkylene group or an isomer thereof, a substituted or unsubstituted C₆-C₃₀ aryl group, a substituted or unsubstituted C₂-C₃₀ heteroaryl group, or a substituted or unsubstituted silyl group; and n is an integer from 1 to 50,000.)

The organic polymer may be aggregated into a plurality of units within the solid electrolyte to form organic polymer flakes. The organic polymer flakes may be dispersed in the solid electrolyte and may form a plate-like structure. The organic polymer may exhibit a first peak in the range of 20 to 50 ppm, a second peak in the range of 50 to 70 ppm, and a third peak in the range of 150 to 210 ppm in ¹³C NMR analysis.

A method for preparing a solid electrolyte according to another embodiment of the present invention comprises: preparing a mixture of an argyrodite powder and an organic monomer; and producing the solid electrolyte by applying high temperature and pressure to the mixture, wherein the organic monomer satisfies the following Chemical Formula 4.

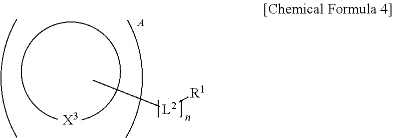

(In Chemical Formula 4, X₃ is O, S, S—S, a substituted or unsubstituted ester, thioester, or dithioester; the functional group A is a substituted or unsubstituted carbon ring having 2 to 10 carbon atoms and comprising one or more X₃ groups; R₁ is hydrogen, deuterium, tritium, a halogen group, a substituted or unsubstituted C₁-C₃₀ alkyl group, a substituted or unsubstituted C₆-C₃₀ aryl group, a substituted or unsubstituted C₂-C₃₀ heteroaryl group, or a substituted or unsubstituted silyl group, acyl group, alkoxy group, ester group, ketone group, aldehyde group, carboxyl group, thioester group, or dithioester group; L₂ is a direct bond, a substituted or unsubstituted C₁-C₁₀ alkylene group or an isomer thereof, a substituted or unsubstituted C₆-C₃₀ aryl group, a substituted or unsubstituted C₂-C₃₀ heteroaryl group, or a substituted or unsubstituted silyl group; and n is an integer from 1 to 50,000.)

In the step of preparing the mixture of the argyrodite powder and the organic monomer, the content of the organic monomer may be from 1 wt % to 15 wt % based on 100 wt % of the total mixture.

In the step of producing the solid electrolyte by applying high temperature and pressure to the mixture, an organic polymer may be formed by the high-temperature and high-pressure treatment, and the mixture and the resulting solid electrolyte may satisfy the following Mathematical Formula 1.

$$1 \leq {M}_{po} / {M}_{mo} \leq 10 \qquad [ Mathematical Formula 1 ]$$

(wherein Mₚₒ is defined by Mathematical Formula 2, and Mₘₒ is defined by Mathematical Formula 3; in Mathematical Formula 2, Pₚₒ−Sₓₚₒ and LSPCLₚₒ represent the amounts of phosphorus-sulfur bonding groups and argyrodite structural bonding groups in the solid electrolyte after the high-temperature and high-pressure treatment; and in Mathematical Formula 3, Pₘₒ−Sₓₘₒ and LSPCLₘₒ represent the amounts of phosphorus-sulfur bonding groups and argyrodite structural bonding groups in the mixture before the high-temperature and high-pressure treatment.)

$$\frac{{P}_{po} - {S}_{{x}_{po}}}{{LPSCl}_{po}} \qquad [ Mathematical Formula 2 ]$$

$$\frac{{P}_{mo} - {S}_{{x}_{mo}}}{{LPSCl}_{mo}} \qquad [ Mathematical Formula 3 ]$$

In the step of producing the solid electrolyte by applying high temperature and pressure to the mixture, an organic polymer may be formed by the high-temperature and high-pressure treatment, and the mixture and the resulting solid electrolyte may satisfy the following Mathematical Formula 4.

$$1 \leq {N}_{po} / {N}_{mo} \leq 10 \qquad [ Mathematical Formula 4 ]$$

(wherein Nₚₒ is defined by Mathematical Formula 5, and Nₘₒ is defined by Mathematical Formula 6; in Mathematical Formula 5,-Sₓₚₒ- and LSPCLₚₒ represent the amounts of sulfur bonding groups and argyrodite structural bonding groups in the solid electrolyte after the high-temperature and high-pressure treatment; and in Mathematical Formula 6, -Sₓₘₒ- and LSPCLₘₒ represent the amounts of sulfur bonding groups and argyrodite structural bonding groups in the mixture before the high-temperature and high-pressure treatment.)

$$\frac{- {S}_{{x}_{po}} -}{{LPSCl}_{po}} \qquad [ Mathematical Formula 5 ]$$

$$\frac{- {S}_{{x}_{mo}} -}{{LPSCl}_{mo}} \qquad [ Mathematical Formula 6 ]$$

In the step of producing the solid electrolyte by applying high temperature and pressure to the mixture, an organic polymer may be formed by the high-temperature and high-pressure treatment, and the organic polymer may be aggregated into a plurality of units within the solid electrolyte to form organic polymer flakes. The organic polymer flakes may be dispersed within the solid electrolyte and may form a plate-like structure.

A non-pressurized secondary battery according to another embodiment of the present invention comprises: a positive electrode; a negative electrode; a solid electrolyte disposed between the positive electrode and the negative electrode; and a porous current collector in contact with the negative electrode, wherein the solid electrolyte comprises the above-described solid electrolyte.

The positive electrode comprises a current collector and a positive electrode active material layer disposed on the current collector, and the positive electrode active material layer may comprise a positive electrode active material in the form of a single particle.

The positive electrode active material layer may comprise the solid electrolyte according to the above-described solid electrolyte.

The positive electrode active material layer may comprise an argyrodite powder.

The negative electrode may be lithium metal or a lithium alloy, and the lithium alloy may comprise from 0.1 wt % to 30 wt % of one or more of Mg, Al, Sn, Sb, Ag, Hf, Ta, Pt, Au, Ti, or La based on 100 wt % of the total lithium alloy.

The thickness of the lithium metal negative electrode may be from 20 to 110 μm. The thickness of the lithium metal negative electrode may be from 35 to 45 μm.

### Effects of the Invention

According to an embodiment of the present invention, the solid electrolyte can secure electrical and chemical stability during operation of a secondary battery by filling internal pores of the solid electrolyte with an organic polymer capable of thermal self-polymerization and suppressing lithium metal growth and reduction. In addition, due to the low reactivity of the organic polymer, the properties of the solid electrolyte are not compromised, thereby improving ionic conductivity.

According to another embodiment of the present invention, the method for manufacturing the solid electrolyte enables the production of a solid electrolyte having the aforementioned advantages.

According to yet another embodiment of the present invention, the non-pressurized secondary battery comprises the solid electrolyte having the above-described advantages, thereby securing electrical and chemical stability and improving ionic conductivity. The non-pressurized secondary battery can accommodate volume changes caused by lithium metal growth and reduction even under low pressure by disposing a porous carbon-based current collector beneath the lithium metal negative electrode.

### BRIEF DESCRIPTION OF THE DRAWINGS

FIG. 1 is an X-ray CT image of a solid electrolyte according to one embodiment of the present invention.

FIG. 2 is a ¹³C NMR spectrum of a polymer according to one embodiment of the present invention.

FIGS. 3 and 4 are XPS spectra before and after high-temperature and high-pressure treatment according to one embodiment of the present invention.

FIG. 5 is a perspective view schematically illustrating the structure of a non-pressurized secondary battery according to one embodiment of the present invention.

FIG. 6 is a graph showing the results of EIS (electrochemical impedance spectroscopy) analysis and ionic conductivity for Reference Examples 1 and 3, Example 1, and Comparative Example 1.

FIG. 7 is a cyclic voltammetry (CV) analysis graph of Example 1 and Comparative Example 1.

FIG. 8 is a scanning electron microscope (SEM) image and P and C element EDS mapping images of Example 1.

FIG. 9 is a charge/discharge graph tested with a pressed symmetric cell using the Reference Example, Example, and Comparative Example.

FIG. 10 is a charge/discharge graph tested with a coin-type symmetric cell using Example 1 and Comparative Example 1.

FIGS. 11 to 13 are charge/discharge graphs tested with full cells for Comparative Example 4, Example 4, and Example 5.

### DETAILED DESCRIPTION OF THE INVENTION

The technical terms used herein are merely for the purpose of describing specific embodiments and are not intended to limit the scope of the present invention. The singular forms used herein are intended to include the plural forms as well, unless the context clearly indicates otherwise. The term “comprising” as used in the specification is intended to specify the presence of stated features, regions, integers, steps, operations, elements, and/or components, but does not preclude the presence or addition of one or more other features, regions, integers, steps, operations, elements, and/or components.

Unless otherwise defined, all technical and scientific terms used herein have the same meanings as commonly understood by one of ordinary skill in the art to which the present invention pertains. Conventionally defined terms used in general dictionaries should be interpreted as having meanings consistent with relevant technical literature and the present disclosure, and are not to be interpreted in an idealized or overly formal sense unless otherwise expressly defined.

In this specification, the term “combinations thereof” as used in Markush-type expressions means one or more mixtures or combinations selected from the group consisting of the components recited in the Markush expression, and includes at least one selected from the group.

Hereinafter, embodiments of the present invention will be described in detail. However, the following description is provided by way of example only and is not intended to limit the present invention, which is defined solely by the scope of the claims to be described below.

### Solid Electrolyte

As described above, conventional solid electrolytes have a problem in that internal short circuits occur when used with lithium metal particles due to lithium metal growth and reduction. To address this issue, the present embodiment provides a solid electrolyte (300) comprising an organic polymer capable of thermal self-polymerization.

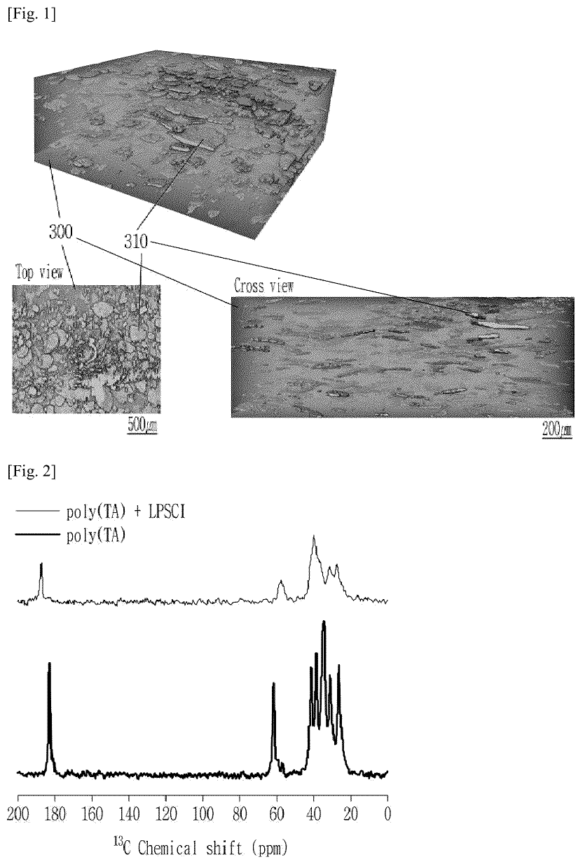

FIG. 1 is an X-ray CT image of a solid electrolyte according to one embodiment.

Referring to FIG. 1, the solid electrolyte (300) includes an organic polymer and organic polymer flakes (310). The organic polymer may form organic polymer flakes (310) by aggregating into multiple units within the solid electrolyte (300). The organic polymer flakes (310) may be stacked in layers within the solid electrolyte (300) in a direction parallel to the positive electrode (100) and the negative electrode (200). In addition, the organic polymer flakes (310) may be dispersed within the solid electrolyte (300), and each of the organic polymer flakes (310) may form a plate-shaped structure in which multiple layers are laminated.

When the organic polymer flakes (310) are present in the solid electrolyte (300) in the above-described form, the growth and reduction of lithium metal within the solid electrolyte (300) can be suppressed. Moreover, the organic polymer flakes (310) can fill internal pores and improve contact between solid electrolyte particles. Through this, advantageous effects such as enhanced electrical and chemical stability can be achieved. Furthermore, since the organic polymer and the organic polymer flakes (310) have low reactivity, they do not interfere with the properties of the solid electrolyte, thereby enabling improvement in ionic conductivity.

The organic polymer may include the following Chemical Formula 1. In addition, a terminal of the organic polymer may include at least one of Chemical Formulas 2 and 3.

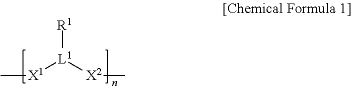

(In Chemical Formula 1,

X₁ and X₂ are each independently O, S, S—S, a substituted or unsubstituted ester, thioester, or dithioester, and at least one of X₁ and X₂ is present;

R₁ is hydrogen, deuterium, tritium, a halogen group, a substituted or unsubstituted C₁-C₃₀ alkyl group, a substituted or unsubstituted C₆-C₃₀ aryl group, a substituted or unsubstituted C₂-C₃₀ heteroaryl group, or a substituted or unsubstituted silyl group, acyl group, alkoxy group, ester group, ketone group, aldehyde group, carboxyl group, thioester group, or dithioester group;

L₁ is a direct bond, a substituted or unsubstituted C₁-C₁₀ alkylene group or an isomer thereof, a substituted or unsubstituted C₆-C₃₀ aryl group, a substituted or unsubstituted C₂-C₃₀ heteroaryl group, or a substituted or unsubstituted silyl group;

and n is an integer from 1 to 50,000.)

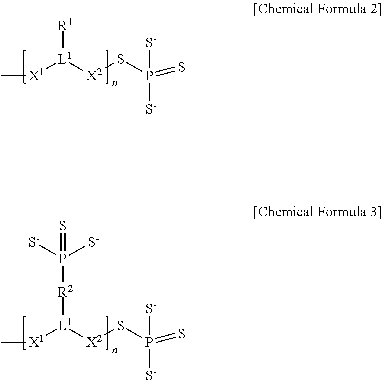

(In Chemical Formulas 2 and 3, X₁ and X₂ are each independently O, S, S—S, a substituted or unsubstituted ester, thioester, or dithioester, and at least one of X₁ and X₂ is present; R₁ is hydrogen, deuterium, tritium, a halogen group, a substituted or unsubstituted C₁-C₃₀ alkyl group, a substituted or unsubstituted C₆-C₃₀ aryl group, a substituted or unsubstituted C₂-C₃₀ heteroaryl group, or a substituted or unsubstituted silyl group, acyl group, alkoxy group, ester group, ketone group, aldehyde group, carboxyl group, thioester group, or dithioester group; R₂ is a substituted or unsubstituted C₁-C₃₀ alkyl group or an isomer thereof, a substituted or unsubstituted C₆-C₃₀ aryl group, a substituted or unsubstituted C₂-C₃₀ heteroaryl group, a substituted or unsubstituted silyl group, acyl group, alkoxy group, ester group, ketone group, aldehyde group, or carboxyl group; L₁ is a direct bond, a substituted or unsubstituted C₁-C₁₀ alkylene group or an isomer thereof, a substituted or unsubstituted C₆-C₃₀ aryl group, a substituted or unsubstituted C₂-C₃₀ heteroaryl group, or a substituted or unsubstituted silyl group; and n is an integer from 1 to 50,000.)

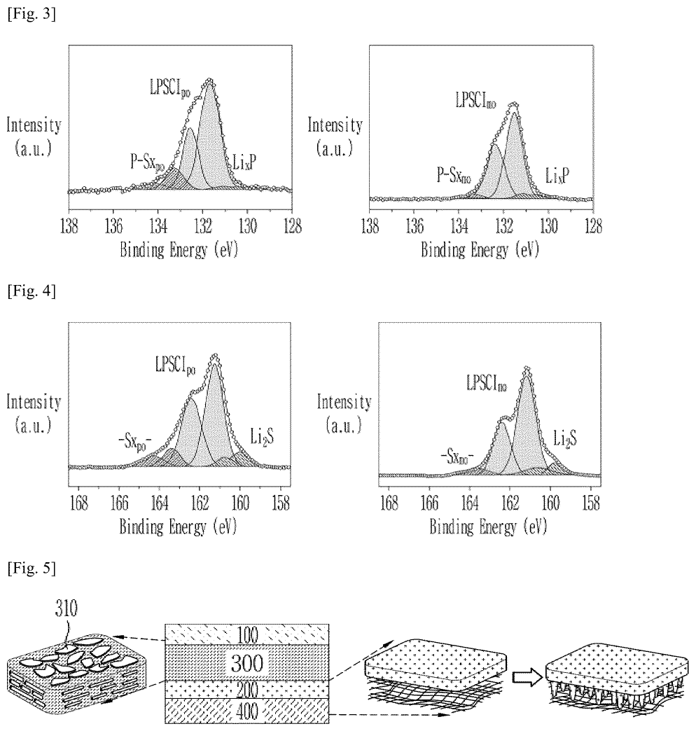

FIG. 2 is a ¹³C NMR spectrum of a polymer according to one embodiment. In FIG. 2, a conventional polymer formed only from thioctic acid is represented by a bold line, and an organic polymer formed under high temperature and pressure in the presence of argyrodite powder is represented by a thin line. It can be confirmed that the conventional polymer and the organic polymer exhibit different peaks in ¹³C NMR. The organic polymer may exhibit a first peak in the range of 20 to 50 ppm, a second peak in the range of 50 to 70 ppm, and a third peak in the range of 150 to 210 ppm.

The first peak corresponds to L₁ in Chemical Formulas 1 to 3, the second peak corresponds to carbon atoms connected to or included in X₁ and X₂ in Chemical Formulas 1 to 3, and the third peak corresponds to carbon atoms connected to or included in X₁ and X₂, or included in R₁, in Chemical Formulas 1 to 3. Compared to the peaks of the conventional polymer, the second and third peaks of the organic polymer show a shift, which is characteristic of the terminal structures of Chemical Formulas 2 and 3 reacting and binding with the solid electrolyte (300) terminals. When the organic polymer includes all of the first to third peaks, it can facilitate cross-linking between organic polymer chains or enhance binding effects with solid electrolyte particles, lithium metal, or positive electrode active material.

If the peak positions fall outside the above ranges, it indicates that the organic polymer is not properly bound to the terminal of the solid electrolyte (300), resulting in degraded binding performance.

The solid electrolyte (300) employs an argyrodite-based solid electrolyte. The argyrodite-based solid electrolyte may be substituted with any sulfide-based solid electrolyte. For example, it may be replaced with one or more selected from the group consisting of Li₂S—P₂S₅, Li₂S—P₂S₅—LiX, Li₆PS₅X (where X is a halogen element, such as I or Cl), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅-ZₘSₙ (where m and n are integers and Z is Ge, Zn, or a), Li₂S—GeS₂, Li₂S—SiS₂—Li₃PO₄, and Li₂S—SiS₂—LiₚMO_{q} (where p and q are integers and M is P, Si, Ge, B, Al, Ga, or In).

### Method for Preparing Solid Electrolyte

A method for preparing a solid electrolyte according to one embodiment may include: preparing a mixture of an argyrodite powder and an organic monomer satisfying the following Chemical Formula 4; and producing the solid electrolyte by applying high temperature and pressure to the mixture.

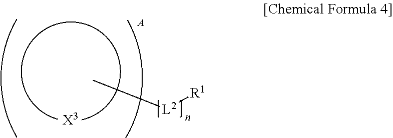

(In Chemical Formula 4, X₃ is O, S, S—S, a substituted or unsubstituted ester, thioester, or dithioester; the functional group A is a substituted or unsubstituted carbon ring having 2 to 10 carbon atoms and comprising one or more X₃ groups; R₁ is hydrogen, deuterium, tritium, a halogen group, a substituted or unsubstituted C₁-C₃₀ alkyl group, a substituted or unsubstituted C₆-C₃₀ aryl group, a substituted or unsubstituted C₂-C₃₀ heteroaryl group, or a substituted or unsubstituted silyl group, acyl group, alkoxy group, ester group, ketone group, aldehyde group, carboxyl group, thioester group, or dithioester group; L₂ is a direct bond, a substituted or unsubstituted C₁-C₁₀ alkylene group or an isomer thereof, a substituted or unsubstituted C₆-C₃₀ aryl group, a substituted or unsubstituted C₂-C₃₀ heteroaryl group, or a substituted or unsubstituted silyl group; and n is an integer from 1 to 50,000.)

In the step of preparing a mixture of the argyrodite powder and the organic monomer satisfying Chemical Formula 4, the content of the organic monomer may be from 1 wt % to 15 wt % based on 100 wt % of the total mixture. Specifically, the content may be from 3 wt % to 10 wt %, and more specifically from 5 wt % to 7 wt %. Satisfying the above range enables improved electrical and chemical stability. If the content of the organic monomer exceeds the upper limit of the range, electrical and chemical stability may degrade due to internal short circuits or excessive charge/discharge overvoltage. Conversely, if the content falls below the lower limit, issues such as unstable charge/discharge or internal short circuits may arise.

In the step of preparing the mixture, the organic monomer may be prepared via vacuum drying. Vacuum drying may be performed at a temperature in the range of 40° C. to 80° C., more specifically from 50° C. to 70° C., and even more specifically from 45° C. to 55° C. The drying time may range from 8 to 16 hours, more specifically from 10 to 14 hours, and even more specifically from 11 to 13 hours. However, these conditions are not limited, and the temperature and time may be adjusted according to the structural properties of the organic monomer.

In this step, the mixture of the argyrodite powder and the organic monomer may be prepared using mechanical milling or a solution method. Mechanical milling is a method in which raw materials are micronized and mixed through strong agitation, such as by a ball mill in a reactor. The argyrodite powder and the organic monomer may be mixed in a zirconia container, but other types of containers suitable for mechanical milling may also be used. Mechanical milling may be performed at an intensity in the range of 100 to 600 RPM, more specifically 150 to 500 RPM, and even more specifically 200 to 300 RPM. The duration may be 1 to 8 hours, more specifically 2 to 6 hours, and even more specifically 3 to 5 hours.

The particle size (D50) of the argyrodite powder may range from approximately 0.5 μm to 30 μm. Here, D50 refers to the median particle size, i.e., the size at which 50% of the powder distribution lies below. Specifically, the D50 may range from 1.0 to 3.0 μm. When this condition is met, the solid electrolyte maintains high ionic conductivity and good mixing uniformity. It also enables dense interfaces between the electrolyte and electrodes, preventing lithium metal penetration and facilitating the full utilization of electrode active material capacity. If the D50 exceeds the upper limit, uniform mixing may deteriorate, interface density may be reduced, and internal short circuits due to lithium metal penetration may occur. If the D50 falls below the lower limit, ionic conductivity may sharply decline, increasing resistance and significantly reducing battery capacity and lifespan.

The organic monomer may include O, S, S—S, substituted or unsubstituted ester, thioester, and dithioester functional groups in the carbon ring. These ring structures, when exposed to heat, may undergo ring-opening polymerization to form a main chain. The resulting polymer may include an organic polymer represented by Chemical Formula 1, which contains reactive groups such as O, S, S—S, ester, thioester, or dithioester. Side chains may also be included in the organic polymer, and may contain various functional groups such as silyl, acyl, alkoxy, ester, ketone, aldehyde, carboxyl, thioester, or dithioester groups. These functional groups may facilitate cross-linking or enhance binding to lithium metal, cathode active materials, and others.

In one embodiment, the organic monomer may include at least one selected from the group consisting of thioctic acid, L-lactide, ε-caprolactone, ε-thiocaprolactone, 1,2-dithiane, β-propiolactone, β-propiothiolactone, propylene oxide, and trans-4,5-dihydroxy-1,2-dithiane.

In the step of producing the solid electrolyte by applying high temperature and pressure to the mixture, the mixture may be pressurized in a moulder having a diameter in the range of 6 to 18Φ. Pressurization may be performed in a pressure range of 100 to 800 MPa, and at a temperature range of 40° C. to 150° C., more specifically from 70° C. to 90° C. The pressurization time may range from 30 minutes to 2 hours, more specifically from 50 minutes to 1 hour. Under these conditions, the organic monomer may undergo thermal self-polymerization to form an organic polymer, which then binds to the terminal of the solid electrolyte (300), thereby improving electrical and chemical stability.

During the pressurization step, the organic monomer may form an organic polymer via thermal self-polymerization. As described above, multiple organic polymer chains may aggregate to form organic polymer flakes (310) within the solid electrolyte (300). The organic polymer flakes (310) may be dispersed throughout the solid electrolyte (300) and form a plate-shaped structure. The details of the plate structure are as previously described.

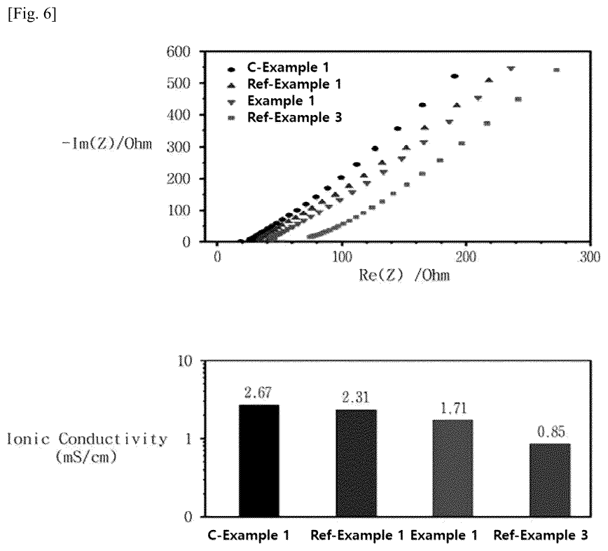

FIGS. 3 and 4 are XPS spectra before and after high-temperature and high-pressure treatment according to one embodiment. FIG. 3 shows spectra measured before and after pressurizing the mixture in the step of producing the solid electrolyte, indicating the presence of phosphorus-sulfur bonding groups and argyrodite structural bonding groups. At this time, the mixture and the solid electrolyte (300) may satisfy the following Mathematical Formula 1.

$$1 \leq {M}_{po} / {M}_{mo} \leq 10 \qquad [ Mathematical Formula 1 ]$$

(Here, Mₚₒ is defined by Mathematical Formula 2, and Mₘₒ is defined by Mathematical Formula 3. In Mathematical Formula 2, Pₚₒ−Sₓₚₒ and LSPCLₚₒ represent the amounts of phosphorus-sulfur bonding groups and argyrodite structural bonding groups in the solid electrolyte after the high-temperature and high-pressure treatment. In Mathematical Formula 3, Pₘₒ−Sₓₘₒ and LSPCLₘₒ represent the amounts of phosphorus-sulfur bonding groups and argyrodite structural bonding groups in the mixture before the high-temperature and high-pressure treatment.)

$$\frac{{P}_{po} - {S}_{{x}_{po}}}{{LPSCl}_{po}} \qquad [ Mathematical Formula 2 ]$$

$$\frac{{P}_{mo} - {S}_{{x}_{mo}}}{{LPSCl}_{mo}} \qquad [ Mathematical Formula 3 ]$$

Mathematical Formula 1 represents the ratio of phosphorus-sulfur bonding groups in the mixture before high-temperature and high-pressure treatment to that in the solid electrolyte (300) after such treatment. Formula 1 may satisfy a value in the range from 1 to 10, and more specifically from 2 to 6. By satisfying the above range, the organic monomer can undergo thermal self-polymerization to form an organic polymer, while also appropriately binding to the terminals of the solid electrolyte (300), thereby enhancing the binding effect and improving electrical and chemical stability.

If the value of Formula 1 exceeds the upper limit of the above range, an excessive amount of organic polymer may be generated, resulting in reduced ionic conductivity and increased charge/discharge overvoltage, which can easily cause internal short circuits. Conversely, if the value of Formula 1 falls below the lower limit of the above range, side reactions between the organic polymer and the solid electrolyte (300) may occur, interfering with the binding effect, reducing ionic conductivity, and increasing overvoltage during charge/discharge, leading to a higher risk of internal short circuits.

Referring to FIG. 4, which shows spectra measured before and after high-temperature and high-pressure treatment in the step of producing the solid electrolyte, the amounts of sulfur bonding groups and argyrodite structural bonding groups can be identified. In this case, the mixture and the solid electrolyte (300) may satisfy the following Mathematical Formula 4.

$$1 \leq {N}_{po} / {N}_{mo} \leq 10 \qquad [ Mathematical Formula 4 ]$$

(In Mathematical Formula 4, Nₚₒ is defined by Mathematical Formula 5, and Nₘₒ is defined by Mathematical Formula 6. In Mathematical Formula 5, -Sₓₚₒ- and LSPCLₚₒ represent the amounts of sulfur bonding groups and argyrodite structural bonding groups in the solid electrolyte after the high-temperature and high-pressure treatment. In Mathematical Formula 6, -Sₓₘₒ- and LSPCLₘₒ represent the amounts of sulfur bonding groups and argyrodite structural bonding groups in the mixture before the high-temperature and high-pressure treatment.)

$$\frac{- {S}_{{x}_{po}} -}{{LPSCl}_{po}} \qquad [ Mathematical Formula 5 ]$$

$$\frac{- {S}_{{x}_{mo}} -}{{LPSCl}_{mo}} \qquad [ Mathematical Formula 6 ]$$

Mathematical Formula 4 represents the ratio of sulfur bonding groups in the mixture before high-temperature and high-pressure treatment to those in the solid electrolyte (300) after such treatment. Formula 4 may satisfy a value in the range from 1 to 10, and more specifically from 2 to 6. By satisfying the above range, the organic monomer undergoes thermal self-polymerization to form an organic polymer, which appropriately binds to the terminal of the solid electrolyte (300), thereby enhancing the binding effect and improving both electrical and chemical stability.

If the value of Formula 4 exceeds the upper limit of the above range, excessive formation of the organic polymer may lead to reduced ionic conductivity and increased charge/discharge overvoltage, resulting in a higher likelihood of internal short circuits. Conversely, if the value falls below the lower limit, side reactions between the organic polymer and the solid electrolyte (300) may interfere with the binding effect, reduce ionic conductivity, and increase overvoltage during charge/discharge, making internal short circuits more likely.

Specific values for Mathematical Formulas 1 to 6 described above are presented in Evaluation Example 7 below.

### Non-Pressurized Secondary Battery

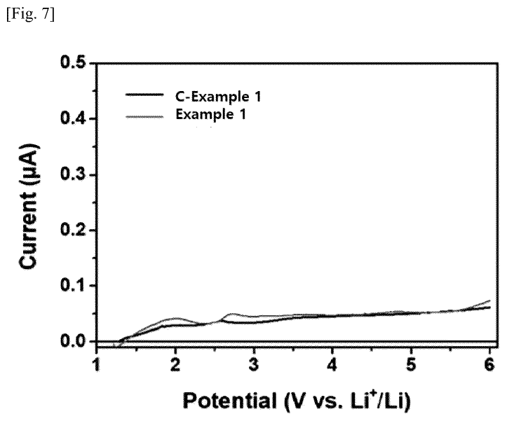

FIG. 5 is a perspective view schematically illustrating the structure of a non-pressurized secondary battery according to one embodiment.

Referring to FIG. 5, the non-pressurized secondary battery may include a positive electrode (100), a negative electrode (200), a solid electrolyte (300), and a porous current collector (400).

The positive electrode (100) may be in contact with one surface of the solid electrolyte (300). The positive electrode (100) may include a current collector and a positive electrode active material layer formed on the current collector. The positive electrode active material layer may include a positive electrode active material, and the active material may be in the form of primary particles. Additionally, the active material layer may include the solid electrolyte (300), which comprises argyrodite powder and the above-described organic polymer.

The positive electrode active material may be a material capable of reversibly intercalating and deintercalating lithium ions. Examples of the positive electrode active material include LiaA_{1-b}B_{1b}D₁₂ (0.90≤a≤1.8, 0≤b≤0.5); LiaE_{1-b}B_{1b}O₂-cD₁c (0.90≤a≤1.8, 0≤b≤0.5, 0≤c≤0.5); LiaE_{2-b}B_{1b}O₄-_{c}D₁c (0.90≤a≤1.8, 0≤b≤0.5, 0≤c≤0.5); LiaNi_{1-b-c}Co_{b}B_{1c}D_{1α}(0.90≤a≤1.8, 0≤b≤0.5, 0≤c≤0.5, 0<α≤2); LiaNi_{1-b-c}Co_{b}B_{1c}O_{2-α}F_{1α} (0.90≤a≤1.8, 0<b≤0.5, 0≤c≤0.5, 0<a<2); LiₐNi_{1-b-c}Co_{b}B_{1c}O_{2-α}F₁₂ (0.90≤a≤1.8, 0≤b≤0.5,0≤c≤0.5,0<α<2); LiₐNi_{1-b-c}Mn_{b}B_{1c}D_{1α}(0.90≤a≤1.8, 0≤b≤0.5, 0≤c≤0.5, 0<a≤2); LiₐNi_{1-b-c}Mn_{b}B_{1c}O_{2-α}F_{1α} (0.90≤a≤1.8, 0≤b≤0.5, 0≤c≤0.5, 0<α<2); LiₐNi_{1-b-c}Mn_{b}B_{1c}O_{2-α}F₁₂ (0.90≤a≤1.8, 0≤b≤0.5, 0≤c≤0.5, 0<α<2); LiₐNi_{b}E_{c}G_{d}O₂ (0.90≤a≤1.8, 0≤b≤b≤0.9, 0≤c≤0.5, 0.001≤d≤0.1); LiₐNi_{b}Co_{c}MnₐGeO₂ (0.90≤a≤1.8, 0≤b≤0.9, 0≤c≤0.5, 0≤d≤0.5, 0.001≤e≤0.1); LiₐNiG_{b}O₂ (0.90≤a≤1.8, 0.001≤b≤0.1); LiₐCoG_{b}O₂ (0.90 ≤a≤1.8, 0.001≤b≤0.1); LiₐMnG_{b}O₂ (0.90≤a≤1.8, 0.001≤b≤0.1); LiₐMn₂G_{b}O₄ (0.90≤a≤1.8, 0.001≤b≤0.1); QO₂; QS₂; LiQS₂; V₂O₅; LiV₂O₅; LiI₁O₂; LiNiVO₄; Li_{(3-f)}J₂(PO₄)₃ (0≤f≤2); Li_{(3-f)}Fe₂(PO₄)₃ (0≤f≤2); or LiFePO₄.

In these formulas, A is Ni, Co, Mn, or a combination thereof; B₁ is Al, Ni, Co, Mn, Cr, Fe, Mg, Sr, V, a rare earth element, or a combination thereof; D₁ is O, F, S, P, or a combination thereof; E is Co, Mn, or a combination thereof; F₁ is F, S, P, or a combination thereof; G is Al, Cr, Mn, Fe, Mg, La, Ce, Sr, V, or a combination thereof; Q is Ti, Mo, Mn, or a combination thereof; I₁ is Cr, V, Fe, Sc, Y, or a combination thereof; and J is V, Cr, Mn, Co, Ni, Cu, or a combination thereof.

The morphology of the positive electrode active material is not particularly limited and may be particulate, for example, spherical, elliptical, or rectangular. The average particle size may range from 1 to 50 μm but is not limited thereto. The average particle size may be determined by measuring the particle diameters observed under a scanning electron microscope and calculating the average.

The negative electrode (200) may be a lithium metal negative electrode. The thickness of the lithium metal may be from 20 to 110 μm, more specifically from 30 to 100 μm, and preferably from 35 to 45 μm. Meeting this thickness range improves contact with the solid electrolyte (300), allowing for high capacity and stable charge/discharge performance even at high voltage. If the thickness falls outside the range, issues such as poor contact or internal short circuits may impair electrical and chemical stability.

The negative electrode (200) may be formed on one surface of the solid electrolyte (300), and the opposite surface of the negative electrode (200) may be in contact with the porous current collector (400). The lithium metal negative electrode may include lithium metal or a lithium alloy capable of reversibly undergoing electroplating, stripping, alloying, or dealloying of lithium. For example, it may include crystalline or amorphous carbon, other metals (Mg, Al, Sn, Sb, Ag, Hf, Ta, Pt, Au, Ti, La), or combinations thereof. Specifically, the lithium alloy may contain 0.1 wt % to 30 wt % of Mg, Al, Sn, Sb, Ag, Hf, Ta, Pt, Au, Ti, or La based on 100 wt % of the total.

The solid electrolyte (300) may be positioned between the positive electrode (100) and the negative electrode (200), with one surface contacting the positive electrode (100) and the other contacting the negative electrode (200). Internal pores of the solid electrolyte (300) may be filled with the organic polymer or organic polymer flakes (310), as described above.

The porous current collector (400) may be a carbon-based current collector composed of carbon fibers. Its thickness may be from 100 to 300 μm, more specifically from 150 to 250 μm. The porous current collector (400) may be in contact with one surface of the negative electrode (200). By accommodating the volume expansion due to lithium metal growth and reduction, it enables stable charge/discharge even under non-pressurized conditions.

The non-pressurized secondary battery may further include a conductive material. Various conductive agents such as VGCF (vapor grown carbon fiber), Super P, C, and CNT (carbon nanotubes) may be used. In one embodiment, the conductive material may be VGCF.

Hereinafter, preferred examples and comparative examples of the present invention will be described. However, these are merely preferred embodiments and are not intended to limit the scope of the invention.

### EXPERIMENTAL EXAMPLE 1: PREPARATION OF SOLID ELECTROLYTE

### Presence of Organic Monomer

### Reference Example 1: Preparation of Solid Electrolyte Containing 3 wt % Organic Monomer

Thioctic acid was vacuum-dried at 50° C. for 12 hours, and then added in an amount corresponding to 3 wt % based on 100 wt % of the total mixture. The thioctic acid was mixed with argyrodite powder having a particle size of 3 μm in a zirconia container and ball-milled at 200 RPM for 4 hours. The argyrodite powder used was Li₆PS₅Cl, a sulfide-based solid electrolyte powder produced and purchased from POSCO JK Solid Solution Co., Ltd.

Subsequently, approximately 120 mg of the resulting mixture was placed into a 12Φ molder and pressurized at 500 MPa at 80° C. for 1 hour. The resulting solid electrolyte had a thickness of approximately 650 μm.

### Comparative Example 1: Preparation of Solid Electrolyte Without Any Additive

120 mg of argyrodite powder (3 μm) was placed into a 120 molder, pressurized at 125 MPa at room temperature for 3 minutes, and subsequently pressurized at 500 MPa at 80° C. for 1 hour.

### Comparative Example 2: Preparation of Solid Electrolyte Containing 5 wt % PEG

PEG (poly ethylene glycol, molecular weight 400, hereinafter PEG400) was vacuum-dried at 100° C. for 12 hours and then added in an amount corresponding to 5 wt % based on 100 wt % of the total mixture. It was mixed with 3 μm argyrodite powder in a mortar for 30 minutes. The resulting mixture (approx. 120 mg) was placed into a 12Φ molder and pressurized at 500 MPa at 80° C. for 1 hour.

### Control of Organic Monomer Content

### Reference Example 2: Same as Reference Example 1 except thioctic acid was used at 4 wt %.

### Example 1: Same as Reference Example 1 except thioctic acid was used at 5 wt %.

### Example 2: Same as Reference Example 1 except thioctic acid was used at 7 wt %.

### Reference Example 3: Same as Reference Example 1 except thioctic acid was used at 10 wt %.

### EXPERIMENTAL EXAMPLE 2: PREPARATION OF POSITIVE ELECTRODE ACTIVE MATERIAL LAYER

Example 3: Preparation of Positive Electrode Active Material Layer Including Solid Electrolyte Containing 5 wt % Organic Monomer

Based on weight percentage, NCM811 primary particles: 1 μm argyrodite powder: VGCF conductive material: thioctic acid=70:28: 2:1.5 were added and ball-milled in a zirconia container at 200 RPM for 4 hours. The resulting powder was further mixed in a mortar for 10 minutes.

### Comparative Example 3: Preparation of Positive Electrode Active Material Layer Including Solid Electrolyte of Comparative Example 1

Based on weight percentage, NCM811 primary particles: 1 μm argyrodite powder: VGCF conductive material=70:28: 2 were added and ball-milled in a zirconia container at 200 RPM for 4 hours. The resulting powder was further mixed in a mortar for 10 minutes.

### EXPERIMENTAL EXAMPLE 3: PREPARATION OF FULL CELL

### Example 4: Full Cell Fabrication Using Solid Electrolyte Containing 5 wt % Organic Monomer and Positive Electrode Active Material Layer of Example 6 (1)

Thioctic acid was vacuum-dried at 50° C. for 12 hours and added in an amount corresponding to 5 wt % of 100 wt % total. It was mixed with 3 μm argyrodite powder in a zirconia container at 200 RPM for 4 hours. Approximately 120 mg of the mixture was placed in a 12Φ molder and pre-pressed at 125 MPa for 3 minutes at room temperature. The positive electrode active material layer prepared in Example 6 was evenly applied to the pressed solid electrolyte to achieve a capacity of 1 mAh/cm². The structure was then pressurized at 500 MPa at 80° C. for 1 hour and cooled. A lithium metal foil (100 μm thick) was placed on the opposite surface of the positive electrode layer, followed by a porous carbon-based current collector. The assembly was pressurized at 50 MPa for 3 seconds to fabricate the full cell. The full cell was assembled into a 2032-type coin cell and aged at room temperature for 3 hours before charge/discharge testing at a rate of 0.1 C. The conditions are summarized in Table 1.

### Example 5: Fabrication of Full Cell Using Solid Electrolyte Containing 5 wt % Organic Monomer and Positive Electrode Active Material Layer of Example 6 (2)

Thioctic acid was vacuum-dried at 50° C. for 12 hours and then added in an amount corresponding to 5 wt % of 100 wt % total. It was mixed with 3 μm argyrodite powder in a zirconia container at 200 RPM for 4 hours. Approximately 120 mg of the mixture was placed into a 12Φ molder and pre-pressed at 125 MPa for 3 minutes at room temperature. Then, the positive electrode active material layer prepared in Example 6 was evenly applied onto the pre-pressed solid electrolyte to achieve a capacity of 1 mAh/cm². This assembly was further pressurized at 500 MPa at 80° C. for 1 hour and then cooled. On the surface opposite to the applied active material layer, a 40 μm-thick lithium metal foil, preheated at 100° C. for 5 to 10 minutes, was laminated. A porous carbon-based current collector was placed on top, and the entire stack was pressurized at 100 MPa for 3 seconds to fabricate the full cell. The fabricated full cell was assembled into a 2032-type coin cell. The assembled coin cell was aged at room temperature for 3 hours and then subjected to charge/discharge testing at a rate of 0.2 C. The conditions are summarized in Table 1 below.

### Comparative Example 4: Fabrication of Full Cell Using Positive Electrode Active Material Layer of Comparative Example 3

120 mg of 3 um argyrodite powder was placed into a 12Φ molder and pre-pressed at 125 MPa for 3 minutes at room temperature. Then, the positive electrode active material layer prepared in Comparative Example 3 was evenly applied onto the pre-pressed solid electrolyte to achieve a capacity of 1 mAh/cm². The structure was pressurized at 500 MPa at 80° C. for 1 hour and cooled.

On the surface opposite to the active material layer, a 100 μm-thick lithium metal foil was laminated, followed by a porous carbon-based current collector. The stack was pressurized at 50MPa for 3 seconds to fabricate the full cell. The full cell was assembled into a 2032-type coin cell. The assembled coin cell was aged at room temperature for 3 hours and then subjected to charge/discharge testing at a rate of 0.1 C. The conditions are summarized in Table 1 below.

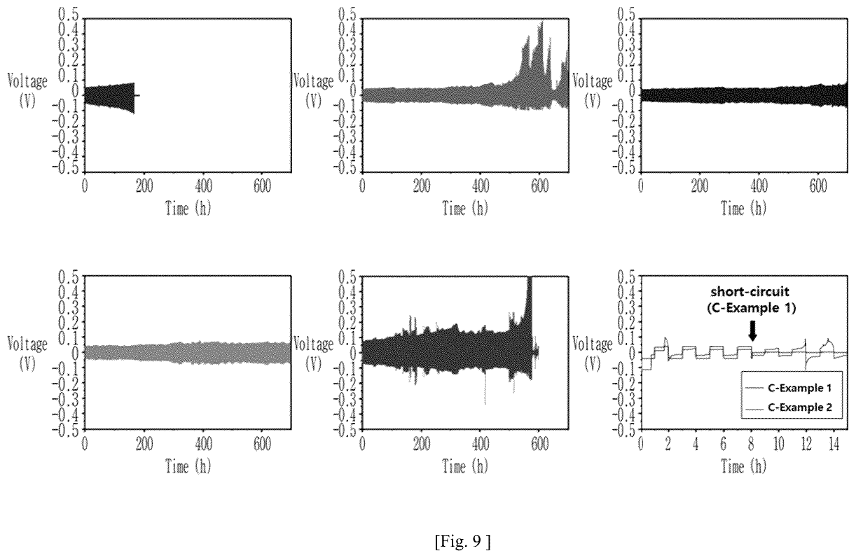

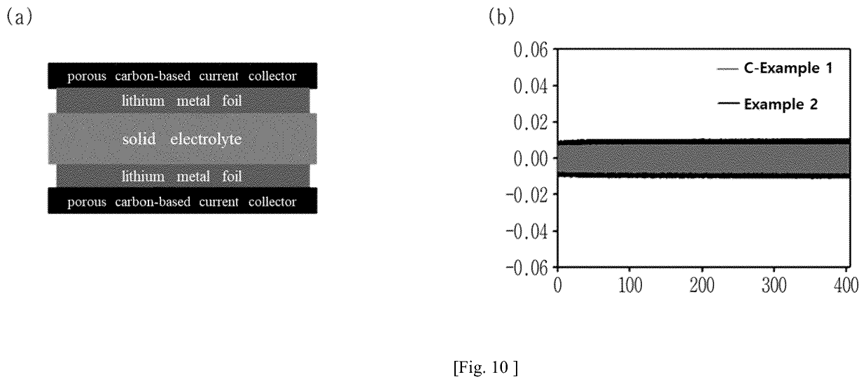

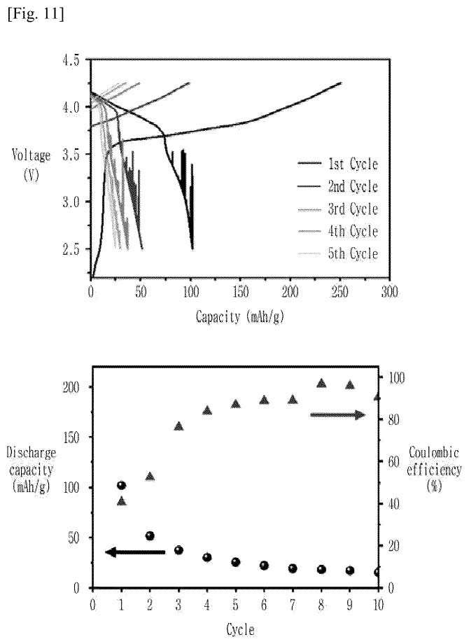

TABLE 1

| | | | | Negative electrode | | |
|---|---|---|---|---|---|---|
| Sample | Positive electrode | Solid Electrolyte | Negative electrode | Current Collector | C-rate (C) | FIG. |
| Comparative | Comparative | Argyrodite | Lithium metal (100 μm) | Porous carbon-based | 0.1 | FIG. 7 |
| Example 4 | Example 3 | | | | | |
| Example 4 | Example 3 | Argyrodite with 5 wt % | Lithium metal (100 μm) | | | FIG. 8 |
| Example 5 | | organic monomer | Lithium metal (40 μm) | | 0.2 | FIG. 9 |

### Evaluation Examples

### Evaluation Example 1: Ionic Conductivity Measurement via EIS Analysis

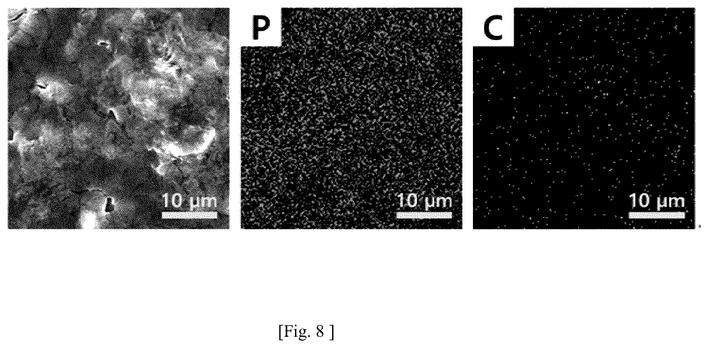

FIG. 6 shows the EIS (electrochemical impedance spectroscopy) results and the corresponding ionic conductivity values for Reference Examples 1 and 3, Example 1, and Comparative Example 1.

(a) of FIG. 6 presents the impedance spectra measured in the frequency range of 1 mHz to 1 MHz under a pressure of approximately 50 MPa at room temperature. (b) of FIG. 6 shows the calculated ionic conductivity. According to (a) and (b) of FIG. 6, despite the in-situ thermal self-polymerization of the organic monomer into a polymeric binder in the reference and example groups, there is no significant decrease in ionic conductivity compared to Comparative Example 1, indicating that the solid electrolyte maintains sufficient ionic conductivity.

### Evaluation Example 2: Electrochemical Stability (CV) Measurement

FIG. 7 shows the cyclic voltammetry (CV) results of Example 1 and Comparative Example 1.

As shown in FIG. 7, 100 μm-thick lithium metal foil was used as both the counter and reference electrodes. To ensure a high surface area, a 1 μm-thick carbon-coated aluminum foil was used as the working electrode. Scans were conducted from open-circuit voltage up to 6 V at a rate of 0.1 mV/s under 10 MPa at room temperature. The CV curves confirm that both Example 1 and Comparative Example 1 exhibit electrochemical stability up to 5.5 V, indicating that the polymer binder formed via in-situ thermal polymerization in Example 1 does not compromise the electrochemical or chemical stability of the electrolyte.

### Evaluation Example 3: Cross-Sectional SEM and EDS Mapping

FIG. 8 presents the SEM image and phosphorus (P) and carbon (C) elemental EDS mapping of Example 1.

As seen in FIG. 8, both P and C elements are uniformly distributed, indicating that the thioctic acid is homogeneously dispersed and has undergone in-situ thermal polymerization to form the organic polymer. P represents the solid electrolyte component, while C indicates the organic polymer.

### Evaluation Example 4: Charge/Discharge Test (Pressed Symmetric Cell)

### Pressed Symmetric Cell Fabrication Conditions:

A 10Φ, 100 μm-thick lithium metal foil was used as the counter electrode, and a 20 μm-thick nickel current collector was employed. The symmetric cell was cycled under 13 MPa at room temperature using 1 mA/cm² and 1 mAh/cm².

FIG. 9 shows the charge/discharge graphs of reference examples, examples, and comparative examples using pressed symmetric cells.
(a) and (b) of FIG. 9: Reference Examples 1 and 2 showed internal short-circuits and unstable charge/discharge due to insufficient organic monomer content.
(c) and (d) of FIG. 9: Examples 1 and 2 showed stable charge/discharge behavior without short-circuits.
(e) of FIG. 9: Reference Example 3 showed high overvoltage and internal short-circuit due to excessive organic monomer content.
(f) of FIG. 9: Comparative Example 1 experienced dendrite-induced short-circuit within 8 hours, and Comparative Example 2 showed high initial overvoltage due to side reactions between PEG400 and argyrodite powder, leading to instability.

### Evaluation Example 5: Charge/Discharge Test (Coin-Type Symmetric Cell) Coin-Type Symmetric Cell Fabrication Conditions:

A 10Φ, 100 μm-thick lithium metal foil and a porous carbon-based current collector were used. Testing was conducted under no pressure at room temperature with 0.2 mA/cm² and 0.2 mAh/cm².

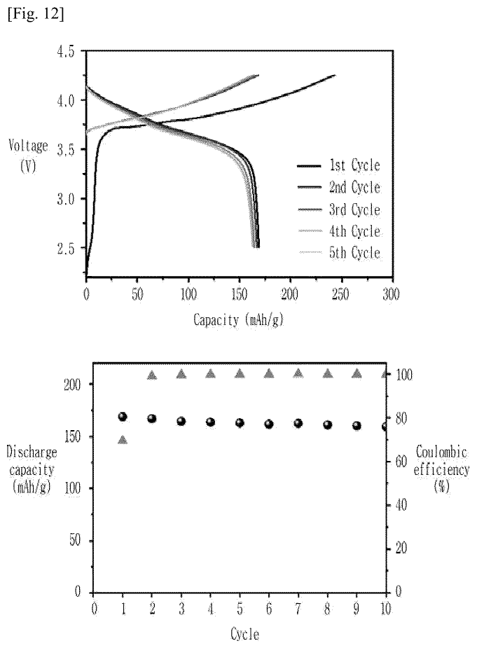

FIG. 10 shows the charge/discharge graphs of Example 1 and Comparative Example 1 using coin-type symmetric cells.
(a) of FIG. 10: Schematic of the coin-type symmetric cell structure.
(b) of FIG. 10: Charge/discharge graph showing that, despite the pressure-free condition, both Example 1 and Comparative Example 1 maintained stable cycling due to lithium accumulation within the pores of the carbon-based current collector.

### Evaluation Example 6: Charge/Discharge Test (Full Cell)

The fabrication and cycling conditions for Comparative Example 4, Example 4, and Example 5 full cells were previously described. All tests were conducted under room temperature and no pressure.

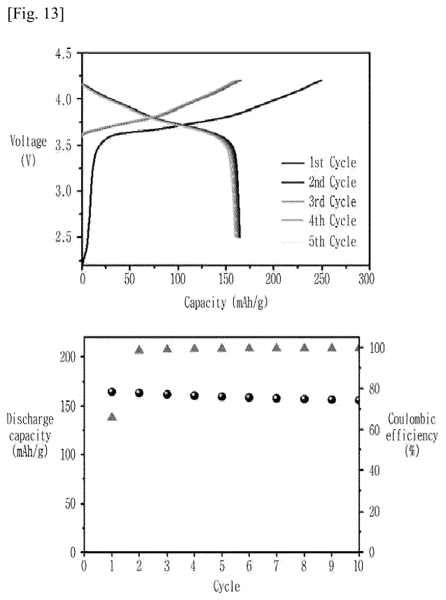

FIGS. 11 to 13 show charge/discharge graphs of full cells based on Comparative Example 4, Example 4, and Example 5, respectively.

FIG. 11: Comparative Example 4 exhibited rapid fading of reversible capacity and unstable cycling.

FIGS. 12 and 13: Examples 4 and 5 demonstrated stable cycling for over 10 cycles due to the inclusion of the organic polymer. In particular, Example 5, which used thinner lithium metal laminated under stronger pressure and higher temperature, showed improved interfacial contact between the lithium and solid electrolyte, resulting in higher capacity and stable cycling at elevated voltages.

### Evaluation Example 7: XPS Graph Analysis (Reference Example 3)

FIGS. 3 and 4 show the XPS spectra before and after high-temperature and high-pressure treatment, as discussed earlier. These figures correspond to Reference Example 3. Table 2 below summarizes the numerical values corresponding to Mathematical Formulas 1 to 6. According to Table 2, Reference Example 3 satisfies both Formulas 1 and 4, confirming that the organic monomer underwent in-situ thermal polymerization and bonded to the terminal of the solid electrolyte (300), thus verifying the effectiveness of the polymerization and binding process.

TABLE 2

| FIG. 3 | Mathematical Formula 1 | Mathematical Formula 2 | Mathematical Formula 3 |
|---|---|---|---|
| | 1 ≤ Mₚₒ/Mₘₒ ≤ 10 | $\frac{{P}_{po} - {S}_{{x}_{po}}}{{LPSCl}_{po}}$ | $\frac{{P}_{mo} - {S}_{{x}_{mo}}}{{LPSCl}_{mo}}$ |
| | 1 ≤ 4.15 ≤ 10 | 0.17 | 0.041 |
| FIG. 4 | Mathematical Formula 4 | Mathematical Formula 5 | Mathematical Formula 6 |
| | 1 ≤ Nₚₒ/Nₘₒ ≤ 10 | $\frac{- {S}_{{x}_{po}} -}{{LPSCl}_{po}}$ | $\frac{- {S}_{{x}_{mo}} -}{{LPSCl}_{mo}}$ |
| | 1 ≤ 2.58 ≤ 10 | 0.17 | 0.066 |

The present invention is not limited to the embodiments described above, and may be implemented in various other forms. Those skilled in the art to which the present invention pertains will understand that the present invention can be embodied in other specific forms without altering its technical spirit or essential features. Therefore, the embodiments described above should be understood as illustrative and not restrictive in every respect.

### DESCRIPTION OF REFERENCE NUMERALS

10: Non-pressurized secondary battery
100: Positive electrode
200: Negative electrode
300: Solid electrolyte
310: Organic polymer flake
400: Porous current collector

1. A solid electrolyte comprising an organic polymer comprising the following Chemical Formula 1: 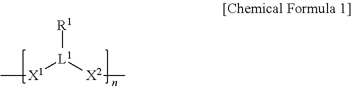
wherein in Chemical Formula 1,
X₁ and X₂ are each independently O, S, S—S, a substituted or unsubstituted ester, thioester, or dithioester, and at least one of X₁ and X₂ is present;
R₁ is hydrogen, deuterium, tritium, a halogen group, a substituted or unsubstituted C₂-C₃₀ alkyl group, a substituted or unsubstituted C₆-C₃₀ aryl group, a substituted or unsubstituted C₂-C₃₀ heteroaryl group, or a substituted or unsubstituted silyl group, acyl group, alkoxy group, ester group, ketone group, aldehyde group, carboxyl group, thioester group, or dithioester group;
L₁ is a direct bond, a substituted or unsubstituted C₁-C₁₀ alkylene group or an isomer thereof, a substituted or unsubstituted C₆-C₃₀ aryl group, a substituted or unsubstituted C₂-C₃₀ heteroaryl group, or a substituted or unsubstituted silyl group;
and n is an integer from 1 to 50,000.

2. The solid electrolyte of claim 1,
wherein a terminal of the organic polymer comprises at least one of Chemical Formula 2 and Chemical Formula 3: 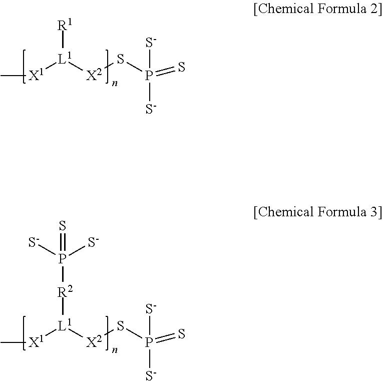
wherein in Chemical Formulas 2 and 3,
X₁ and X₂ are each independently O, S, S—S, a substituted or unsubstituted ester, thioester, or dithioester, and at least one of X₁ and X₂ is present;
R₁ is hydrogen, deuterium, tritium, a halogen group, a substituted or unsubstituted C₁-C₃₀ alkyl group, a substituted or unsubstituted C₆-C₃₀ aryl group, a substituted or unsubstituted C₂-C₃₀ heteroaryl group, or a substituted or unsubstituted silyl group, acyl group, alkoxy group, ester group, ketone group, aldehyde group, carboxyl group, thioester group, or dithioester group;
R₂ is a substituted or unsubstituted C₁-C₃₀ alkyl group or an isomer thereof, a substituted or unsubstituted C₆-C₃₀ aryl group, a substituted or unsubstituted C₂-C₃₀ heteroaryl group, a substituted or unsubstituted silyl group, acyl group, alkoxy group, ester group, ketone group, aldehyde group, or carboxyl group;
L₁ is a direct bond, a substituted or unsubstituted C₁-C₁₀ alkylene group or an isomer thereof, a substituted or unsubstituted C₆-C₃₀ aryl group, a substituted or unsubstituted C₂-C₃₀ heteroaryl group, or a substituted or unsubstituted silyl group;
and n is an integer from 1 to 50,000.

3. The solid electrolyte of claim 1,
wherein the organic polymer is aggregated into a plurality of units within the solid electrolyte to form organic polymer flakes.

4. The solid electrolyte of claim 3,
wherein the organic polymer flakes are dispersed within the solid electrolyte and form a plate-shaped structure.

5. The solid electrolyte of claim 1,
wherein the organic polymer has a first peak in the range of 20 to 50 ppm, a second peak in the range of 50 to 70 ppm, and a third peak in the range of 150 to 210 ppm, as measured by ¹³C NMR.

6. A method for preparing a solid electrolyte, comprising:
preparing a mixture of an argyrodite powder and an organic monomer; and
producing the solid electrolyte by applying high temperature and pressure to the mixture, wherein the organic monomer satisfies the following Chemical Formula 4: 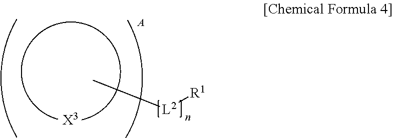
where in Chemical Formula 4,
X₃ is O, S, S13 S, a substituted or unsubstituted ester, thioester, or dithioester;
the functional group A is a substituted or unsubstituted carbon ring having 2 to 10 carbon atoms and comprising one or more X₃ groups;
R₁ is hydrogen, deuterium, tritium, a halogen group, a substituted or unsubstituted C₁-C₃₀ alkyl group, a substituted or unsubstituted C₆-C₃₀ aryl group, a substituted or unsubstituted C₂-C₃₀ heteroaryl group, or a substituted or unsubstituted silyl group, acyl group, alkoxy group, ester group, ketone group, aldehyde group, carboxyl group, thioester group, or dithioester group;
L₂ is a direct bond, a substituted or unsubstituted C₁-C₁₀ alkylene group or an isomer thereof, a substituted or unsubstituted C₆-C₃₀ aryl group, a substituted or unsubstituted C₂-C₃₀ heteroaryl group, or a substituted or unsubstituted silyl group;
and n is an integer from 1 to 50,000.

7. The method for preparing a solid electrolyte of claim 6,
wherein in the step of preparing the mixture of the argyrodite powder and the organic monomer,
the content of the organic monomer is from 1 wt % to 15 wt % based on 100 wt % of the total mixture.

8. The method for preparing a solid electrolyte of claim 6,
wherein in the step of producing the solid electrolyte by applying high temperature and pressure to the mixture,
an organic polymer is formed by the high-temperature and high-pressure treatment,
and the mixture and the solid electrolyte satisfy the following Mathematical Formula 1:
$$1 \leq {M}_{po} / {M}_{mo} \leq 10 \qquad [ Mathematical Formula 1 ]$$
wherein Mₚₒ is defined by Mathematical Formula 2, and Mₘₒ is defined by Mathematical Formula 3,
in which, in Mathematical Formula 2, Pₚₒ−Sₓₚₒ and LSPCLₚₒ represent the amounts of phosphorus-sulfur bonding groups and argyrodite structural bonding groups in the solid electrolyte after the high-temperature and high-pressure treatment,
and in Mathematical Formula 3, Pₘₒ−Sₓₘₒ and LSPCLₘₒ represent the amounts of phosphorus-sulfur bonding groups and argyrodite structural bonding groups in the mixture before the high-temperature and high-pressure treatment
$$\frac{{P}_{po} - {S}_{{x}_{po}}}{{LPSCl}_{po}} \qquad [ Mathematical Formula 2 ]$$
$$\frac{{P}_{mo} - {S}_{{x}_{mo}}}{{LPSCl}_{mo}} \qquad [ Mathematical Formula 3 ]$$

9. The method for preparing a solid electrolyte of claim 6,
wherein in the step of producing the solid electrolyte by applying high temperature and pressure to the mixture,
an organic polymer is formed,
and the mixture and the solid electrolyte satisfy the following Mathematical Formula 4:
$$1 \leq {N}_{po} / {N}_{mo} \leq 10 \qquad [ Mathematical Formula 4 ]$$
wherein Nₚₒ is defined by Mathematical Formula 5, and Nₘₒ is defined by Mathematical Formula 6,
in which, in Mathematical Formula 5, -Sₓₚₒ- and LSPCLₚₒ represent the amounts of sulfur bonding groups and argyrodite structural bonding groups in the solid electrolyte after the high-temperature and high-pressure treatment, and in Mathematical Formula 6, -Sₓₘₒ- and LSPCLₘₒ represent the amounts of sulfur bonding groups and argyrodite structural bonding groups in the mixture before the high-temperature and high-pressure treatment
$$\frac{- {S}_{{x}_{po}} -}{{LPSCl}_{po}} \qquad [ Mathematical Formula 5 ]$$
$$\frac{- {S}_{{x}_{mo}} -}{{LPSCl}_{mo}} \qquad [ Mathematical Formula 6 ]$$

10. The method for preparing a solid electrolyte of claim 6,
wherein an organic polymer is formed by the high-temperature and high-pressure treatment,
the organic polymer is aggregated into a plurality of units within the solid electrolyte to form organic polymer flakes,
and the organic polymer flakes are dispersed within the solid electrolyte and form a plate-shaped structure.

11. A non-pressurized secondary battery, comprising:
a positive electrode;
a negative electrode;
a solid electrolyte disposed between the positive electrode and the negative electrode; and
a porous current collector in contact with the negative electrode,
wherein the solid electrolyte is the solid electrolyte according to any one of claim 1.

12. A non-pressurized secondary battery, comprising:
a positive electrode;
a negative electrode;
a solid electrolyte disposed between the positive electrode and the negative electrode; and
a porous current collector in contact with the negative electrode,
wherein the solid electrolyte is the solid electrolyte according to any one of claim 2.

13. The non-pressurized secondary battery of claim 11,
wherein the positive electrode comprises a current collector and a positive electrode active material layer disposed on the current collector,
and the positive electrode active material layer comprises a positive electrode active material in the form of a single particle.

14. The non-pressurized secondary battery of claim 13,
wherein the positive electrode active material layer comprises the solid electrolyte.

15. The non-pressurized secondary battery of claim 13,
wherein the positive electrode active material layer comprises the solid electrolyte.

16. The non-pressurized secondary battery of claim 13,
wherein the positive electrode active material layer comprises the solid electrolyte.

17. The non-pressurized secondary battery of claim 13,
wherein the positive electrode active material layer comprises an argyrodite powder.

18. The non-pressurized secondary battery of claim 13,
wherein the negative electrode is lithium metal or a lithium alloy, and the lithium alloy comprises from 0.1 wt % to 30 wt % of one or more of Mg, Al, Sn, Sb, Ag, Hf, Ta, Pt, Au, Ti, or La based on 100 wt % of the total lithium alloy.

19. The non-pressurized secondary battery of claim 13,
wherein a thickness of the negative electrode is from 20 to 110 μm.

20. The non-pressurized secondary battery of claim 12.
wherein a thickness of the negative electrode is from 35 to 45 μm.
